(19) United States
(12) Patent Application Publication
(10) Pub. No.: US 2015/0021344 A1
(43) Pub. Date: Jan. 22, 2015

(54) SECTIONAL CONTAINER WITH A DETACHABLE BASE AND LID COVER

(71) Applicant: John Lewis SULLIVAN, Harrisburg, NC (US)

(72) Inventor: John Lewis SULLIVAN, Harrisburg, NC (US)

(21) Appl. No.: 14/510,297

(22) Filed: Oct. 9, 2014

Related U.S. Application Data
(63) Continuation of application No. 12/799,714, filed on Apr. 30, 2010, now Pat. No. 8,857,636.
(60) Provisional application No. 61/281,092, filed on Nov. 12, 2009.

(51) Int. Cl. B65D 6/00; B65D 6/24; B05B 11/00

(52) U.S. Cl. CPC B65D 11/10; B05B 11/3001; B65D 11/1866; B65D 11/188
USPC 220/693; 222/383.1

(57) ABSTRACT

A sectional liquid dispensing (lotions, creams, soaps, cleansers, etc.) container that includes a finger actuated pump assembly which extends a dip tube near the bottom of a container. The container has three individual components to form the complete assembly. The upper section of container has been designed to contain a tamper evident closure member; mold incorporated at its lower most edge. The lower section (base); containing a closure member mold incorporated onto its top edge, is designed to snap fit into upper section of container. The lower section is approximately one third the height of container or less. The lid cover snaps onto the bottom surface of the lower section, using the tamper evident closure member. The usage of these closures provide frangible edges for easy removal of locking tear bands; which allow for separation of components, while also providing evidence of any product tampering. When finger pump assembly fails to dispense the remaining liquids in the container; the bottom half of container is then detached to access liquids. The upper half of container and pump assembly can then be discarded. A lid cover is provided to protect remaining liquids from contamination and excess drying. The lid cover is designed to snap-fit onto the bottom edge and underneath the containers lower section. The present design provides for dual dispensing (two individual products) from one container when upper section has been modified into a separate enclosure. The usage of dual finger actuated pumps may be used. The sectional container allows consumers to regain usage of those liquids or creams otherwise lost.

### CROSS-REFERENCE TO RELATED APPLICATION

The present application is a U.S. continuation patent application of, and claims priority under 35 U.S.C. §120 to, U.S. nonprovisional patent application Ser. No. 12/799,714, filed Apr. 30, 2010, which nonprovisional patent application published as U.S. patent application publication no. 2011/0108507A1 on May 12, 2011 and issued as U.S. Pat. No. 8,857,636 on Oct. 14, 2014, which patent application, publication, and patent are incorporated by reference herein, and which application is a U.S. nonprovisional patent application of, and claims priority under 35 U.S.C. §119(e) to, U.S. provisional patent application Ser. No. 61/281,092, filed Nov. 12, 2009 by the present inventor, which provisional patent application is incorporated by reference herein.

### BACKGROUND OF THE PRESENT INVENTION

1. Field of the Present Invention

This invention generally relates to leak proof plastic containers or bottles; which are used to dispense healthcare lotions and creams. In particular, containers or bottles, which are capable of being separated into two individual sections.

2. Background

Plastic containers come in many shapes, sizes, and colors. Containers of this type are usually made of such plastics as PET (Polyethylene Terphthalate), PVC (Polyvinyl Chloride), or HDPE (High Density Polyethylene) and manufactured using blow or injection molding techniques. Lotions, creams, and body soap dispenser containers are generally molded with a neck at the top of a container; which receives a finger actuated pump assembly, to dispense liquid contents. Most lotion containers have a single unit for storing liquids and are disposable once pump assembly is no longer capable of dispensing its contents.

One problem with the existing containers is that they allow a portion of the liquids to remain in the containers after their primary means of dispensing is exhausted; therefore, a large amount of the product is eventually thrown away. Manufacturers have designed other containers, (i.e. squeeze tubes and inverted tubes) in an effort to make consumers think that these products allow them to use all the liquids within its container. However, in most cases, liquids remain within these containers regardless of consumer efforts at retrieving them.

The present container has an upper section and a lower section (base) assembled together by means of a tamper evident closure assembly which; as assembled, constitute the sectional container. Upon separation into its individual sections, said container provides consumers access to the remaining liquids. Additionally, attached to the bottom of lower section (base) is a lid cover that is used to protect those liquids that remain in the lower section (base). Said lid cover is initially attached to the base by compression fitting said tamper evident closure lid onto beads molded onto the periphery of the lower section (base).

The separation of the upper section is made possible by removing the frangible band that locks it onto the lower section (base). Similar, prior tamper evident closure caps have performed the basic function of providing only secure capping of container contents. The present container provides a sectional container that provides access to the container liquids that in most cases would be lost to individual consumers; especially with those containers having more heavier bodied liquids. The present container provides for an additional feature, a lid cover for said base container. Said cover is attached underneath the base containers bottom by a compression fitted (push on) assembly operation.

Previously, tamper evident closures as shown in U.S. Pat. No. 5,553,727 which issued to Consumer Cap Corporation, as well as many others provide for simple secure capping of a container at its opening. Thus these closure designs provide only secure tamper evident closure and the ability for temporary re-capping of the opening. The present container provides tamper evident closure and expands the realm of its design usage, by expanding the vessel to which it is applied. The present container takes the tamper evident closure feature and creates a new type of application, a connector for components; thus giving the realized container additional usage. The additional usage includes; not only the accessing of liquids, that would have otherwise been lost, but now the consumer has gained the use of a base and lid cover. A base and cover that can be re-filled (as consumers re-purchase new product) with additional liquids, which can be used in other rooms or for travel purposes. The resulting base and lid cover can be compared to the individual cream and lotion jars currently in the marketplace. While the presently preferred embodiment of the container or bottle is made with the use of plastics, other suitable materials maybe used. Such materials include, but are not limited to rubber, waterproof fabrics, collapsible metals, etc.

There are other groups of tamper evident closure assemblies that rely on different interlocking designs. They include threads, teeth and serrations in order to achieve closure assembly. Said closure designs; having these extending thread designs, with respect to cylindrical containers are adaptable and can be used with present container. The application with cylindrical containers and the present containers provide for an alternate attachment application design. These closures, such as shown in U.S. Pat. No. 5,553,727 to the Consumer Cap Corporation and many others illustrate possible thread designs. Thus by incorporation of such thread designs within the design and scope of present containers supplements its utility. Hence, the present container provides for a liquid tight seal as a result of the accurate sealing surfaces of its molding process and design, and thus expands its usage beyond simple round containers to the unlimited container shapes and sizes.

### SUMMARY OF THE PRESENT INVENTION

In accordance with one embodiment, a sectional container with a detachable base and lid cover designed to receive a disclosed thumb actuated pump assembly. Sectional members are joined together by compression fitting sections using a mold integrated tamper evident closure member. The base is detachable by removing the frangible band and pulling the two sections apart. The inclusion of a detachable lid cover allows for the covering and protecting of liquids that remains in container when the primary dispensing function fails.

The invention provides a tightly sealed container capable of being separated into individual sections. In its assembled design, an upper section and a lower section, provides the function of a one piece container. When present container is sectionalized, the lower section provides consumers access to liquids that remain at the bottom of said containers. Thus, the present container gives those consumers who purchase body lotions and creams, the usage of liquids often discarded with the usage of prior designs. Consumers can realize some monetary savings within their healthcare budget with the usage of present invention.

In another embodiment of the container; a dual dispensing container is made possible by converting the upper section of the container into a separately enclosed unit. A second finger actuated pump assembly is attached to an additional mold incorporated neck, along with a channel that allows for extending the dip tube to the bottom of the lower section. This container design allows for dispensing liquids that consumers would use in a combination (i.e. hair conditioners & shampoo, facial scrubs & facial lotions, hand sanitizer & hand lotions, etc.). This novel container gives consumers the additional benefit of having two key healthcare products in one package and the ability to use either product without the need to physically handle products for usage, thus eliminating the possibility of one of the products slipping from your hands during usage.

Thus, the present invention uses the tamper evident closure attachment in an innovative manner; a connector, that opens up new opportunities of function. The closure assembly makes it virtually impossible to tamper with product contents without showing signs of tampering. A sectional container manufactured into three individual components and assembled together by compression fitting each together.

While I have shown and described several embodiments in accordance with the present invention, it is to be understood that the invention is not limited thereto, but is susceptible to numerous changes and modifications as known to a person skilled in the art, and I therefore do not wish to be limited to the details shown and described herein but intend to cover all such changes and modifications as are obvious to one of ordinary skill in the art.

### BRIEF DESCRIPTION OF THE DRAWINGS

FIG. 1 is a perspective view of a presently preferred embodiment;

FIG. 1A is a front view with the disclosed finger actuated pump;

FIG. 2 is a front view of upper section; the said finger actuated pump removed;

FIG. 3 is a front view of lower section (base);

FIG. 4 is a front view of lid cover;

FIG. 5 is a side view of the front and rear product labels;

FIG. 6 is an enlarged vertical sectional view (6-6) of the structure of container walls and neck;

FIG. 7 is an exploded view of the structure of FIG. 6 (upper section) showing the closure members disassembled;

FIG. 8 is a schematic view of the interior of the outer skirt developed in a plane to show the intersections of the upper and lower locking beads of the upper container;

FIG. 9 is a schematic view of the interior of the outer skirt developed in a plane to show the intersections of the upper and lower locking beads of the lid cover.

FIG. 10 is a front view of alternate design of lower section (base);

FIG. 11 is a front view of the alternate design of the snap-on lid cover;

FIG. 12 is a perspective view of an alternate embodiment of the sectional container; dual dispensing from one container;

FIG. 13 is a front view of the upper section of said alternate embodiment;

FIG. 14 is a front view of the lower section (base) of said alternate embodiment;

FIG. 15 is a front view of the lid cover of said alternate embodiment;

FIG. 16 is a side view of front and rear labels of said alternate embodiment; two front and two rear labels;

FIG. 17 is an enlarged sectional view (17-17) of the interior structure of said upper alternate embodiment, showing the interlocking ridges for assembly;

FIG. 18 is an exploded view of the structure of FIG. 17 (upper section) showing the closure members disassembled;

FIG. 19 is a sectional view of lid cover of said alternate embodiment;

FIG. 20 is a sectional view of the interior structure of said upper alternate embodiment, with the disclosed finger actuated pump assemblies attached;

FIG. 21 is a sectional view of the interior structure of said upper alternate embodiment, with the interior channel (item 162) in its assembled position; and

FIG. 22 is a front view of the interior channel (item 162) of said alternate embodiment.

### DETAILED DESCRIPTION

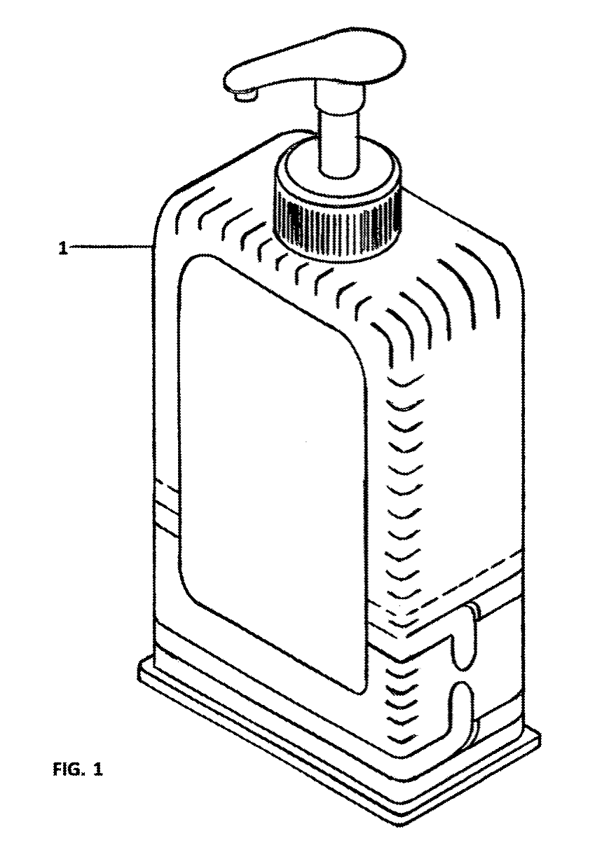

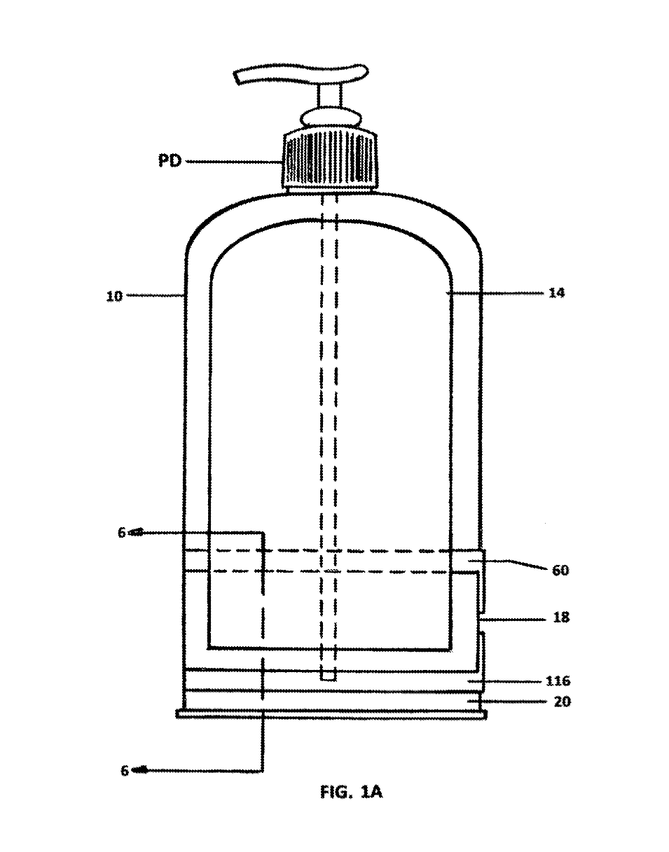

As shown in FIG. 1 and FIG. 1A, a disclosed finger actuated pump dispenser PD is attached to the top of a sectional container 10 by attachment to the upwardly extending neck 12 of the upper portion container 10. The said pump dispenser PD may be of any commercially available type such as finger-operated pumps used for dispensing healthcare lotions, creams, and soaps. The lower portion container (base) 18, in its assembled position is locked into the bottom edge of said upper portion 10 by means of the tamper evident tear band 60. Attached underneath the said base 18 and locked into its assembled position by means of a tamper evident tear band 116, is the lid cover 20 for said base 18. Considering the said container 10 in its assembled position; located and adhered to the front and rear surface of container 10 are two adhesive product information labels 14 and 16. The term container used herein is deemed to include a bottle.

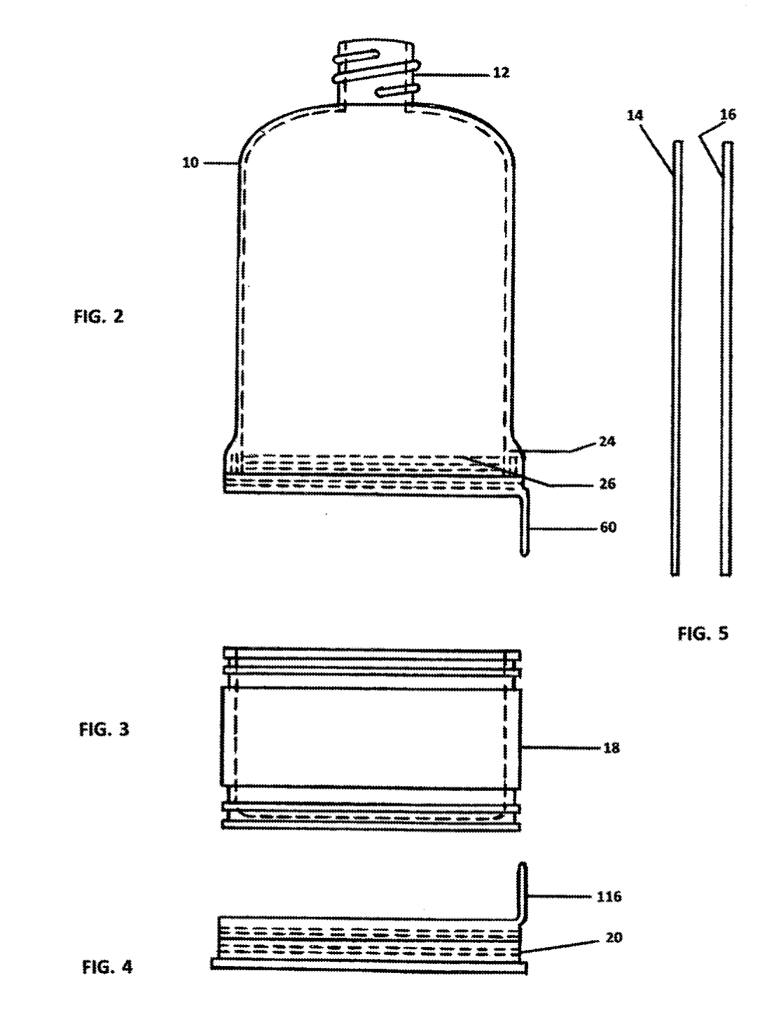

Referring to FIG. 1A, FIG. 2, FIG. 3, FIG. 4, and FIG. 5 The assembly of the upper section 10 and the lower section (base) 18 is performed by means of a downward movement of upper section 10 from the position of FIG. 2 to the seated position of FIG. 1. The lower skirt of the tamper evident tear band 60 stretches to permit the slanted neck surfaces of the said base 18 to slide over the ridged surfaces of said tear band 60. The continued downward compression of said upper portion 10, until the neck 74 of said base 18 snaps into its position against the bottom surface of angled wall 24. In this position, which locks the two sections together, provides for a tightly sealed container.

As shown in FIG. 3 and FIG. 4 the lower base 18, which has molded onto the bottom periphery, are ridges that allow the lid cover assembly 20 to attach. Said lid cover 20 has molded into its uppermost edge a tamper evident closure 116 that stretches upon alignment and compression to permit the slanted interior surfaces to slide over the said ridges of base 18 periphery.

As can be seen in FIG. 5; a front adhesive label 14 and a rear adhesive label 16, which are positioned and placed in their desired locations. Said labels 14, 16 are manufactured to contain perforated lines that are aligned with the tear lines of the frangible band of said closure outer skirt 36. In the assembled position, said labels 14, 16 also provide additional closure and seal protection for container contents.

Considering the separation of the container, as can be seen in FIG. 2, FIG. 3, and FIG. 4 the sectional container is divided into its individual components by tearing and lifting off frangible tear bands 60 and 116. Said upper section 10 can then been snapped-off the lower section 18 and the said lid cover 20 can be snapped-off the underside of said base 18.

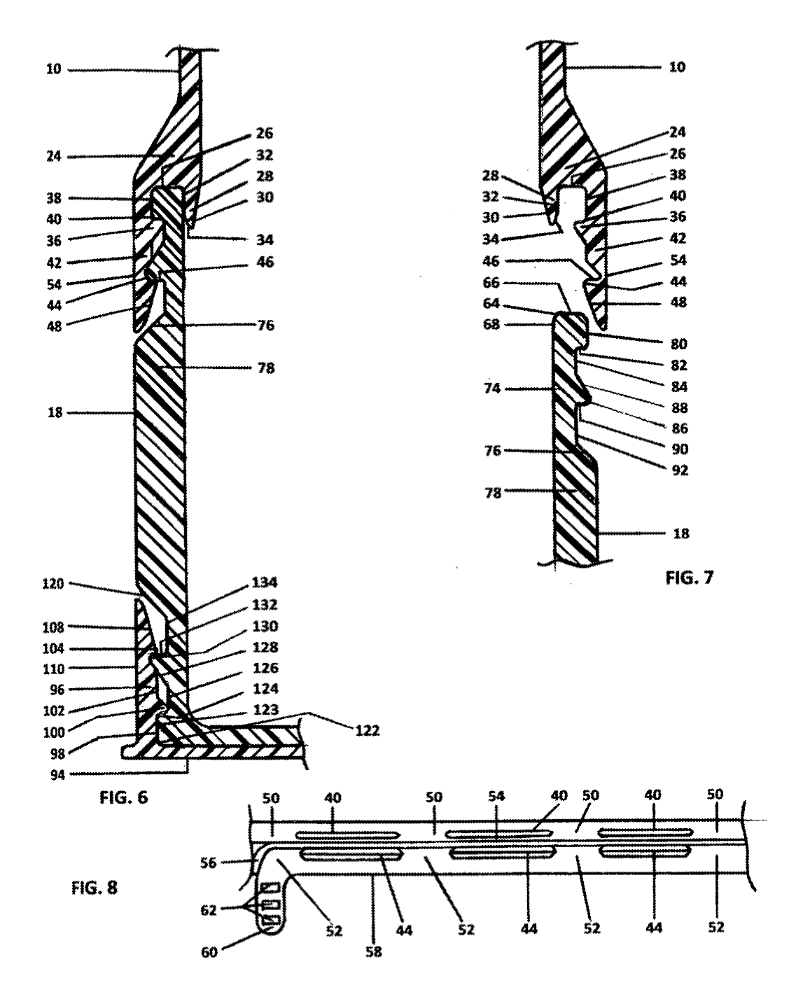

FIG. 6 Shows an exploded view of the container, The upper section of container 10 comprises along the bottom edge an angular internal wall 24 having a planar under surface 26. As is best shown in FIG. 6; an exploded sectional view 6-6, suspended from the underside of said wall 24 is an interior skirt 28 which is relatively short and has an outwardly-downwardly slanted inner sealing surface 32, a substantially vertical outer wall 30 and an inwardly downwardly tapered edge 34 which merges with the lower edge of inner sealing surface 32.

Outwardly spaced from the interior skirt 28 is the closure assembly outer skirt 36 which has a substantially vertical outer wall. Considering the inner wall of the closure assembly outer skirt 36, extending down from internal wall 26 is a substantially vertical top wall 38 of the length about equal to that of interior skirt 28, which terminates in an internal first bead 40. The outwardly slanted surface 42 of said bead 40 terminates at the horizontal tear groove 54. Horizontal tear line 54 merges with the slanted top surface 46 which intersects with the inclined lower surface 48 to form internal lower bead 44. As is best shown in FIG. 8, said beads 40 and 44 are not continuous (not circumferential) but are interrupted with short upper gap 50 and lower gap 52, respectively. Hence, the wall thickness of the outer skirt 36 at the said gaps 50 and 52 is considerably thinner than at the said beads 40 and lower bead 44. This permits stretching of the outer skirt 36 during assembly. The upper beads 40 between upper gaps 50 are considerably longer than upper gaps 50, quantity and size may vary. The lower bead sections 44 are considerably longer than sections 52. The long beads 40 prevent upper container section 10 from being removed when the outer skirt 36 is intact. Spaced immediately above the top surface of lower bead 44 is a horizontal teat line 54 formed on the interior of outer skirt 36 to permit tearing. As shown in FIG. 8, extending upwardly in a slightly spiral configuration is spiral groove 56 which extends from the bottom skirt edge 58 of said outer skirt 36 to merge with the horizontal tear line 54. A frangible tear band 60 which may be easily gripped with the fingers extends from the bottom skirt edge 58 immediately to one side of spiral groove 56. To facilitate gripping frangible tear band 60, raised traverse ridges 62 may be formed thereon. It will be noted that the slanted top surface 46 of internal lower bead 44 are spaced downwardly within the horizontal groove 54.

FIG. 3, FIG. 6 and FIG. 7 Show an exploded sectional of the container base, the vertical neck 74 of lower section (base) 18 at the top; and best shown in FIG. 7, there is a horizontal inwardly turned top flange 64 having substantially flat horizontal sealing surface 66 dimensioned to fit against the underside of the interior angled wall 24 between the interior skirt 28 and outer skirt 36. Describing, first, the interior surface of upper neck 74, proceeding downwardly from horizontal sealing surface 66 at a substantially right angle is a short first vertical sealing surface 68. Said surface 68 seats against interior skirt 28 causing it to bend slightly outward, forming a liquid tight seal. The vertical sealing surface 68 is extremely smooth and continuous; and extends to the bottom interior surface of the lower section (base) 18.

The exterior of upper neck 74; shown in FIG. 7, extending vertically downward from surface 66 is an external neck bead 80 which terminates at a sharp angle with horizontal shoulder 82. The length of neck bead 80 is such that the first bead 40 of the outer skirt 36 in assembled condition seats immediately under horizontal shoulder 82 and holds the upper container section 10 in position, even when the horizontal tear line 54 has been torn. Below the horizontal shoulder 82 is a second vertical exterior surface 84 which is substantially lesser diameter than neck bead 80. Said surface 84 terminates in external neck bead 86. Said bead 86 has an outwardly-downwardly upper slant surface 88 which is rounded and merges with lower horizontal surface 90. Below said bead 86 there is a third lower vertical surface 92 which then merges with the external surface of the thicken base wall 78, formed by the intersection of angled exterior surface 76 and vertical neck 74.

FIG. 2, FIG. 3, FIG. 7 and FIG. 8 show that the assembly of the upper container section 10 and lower section (base) 18, a downward movement of upper section 10 from the position of FIG. 2 to the seated position of FIG. 1. The outer skirt 36 stretches to permit the inclined lower surface 48 of lower bead 44 to slide over the first corner where the horizontal surface 66 and neck bead 80 intersect and then slide over neck bead 86. Similarly, the rounded first bead 40 slides over said shoulder 82 and neck bead 80. In the seated position of FIG. 1, the first bead 40 is seated under the shoulder 82 and the lower bead 44 is seated under the horizontal surface 90. There is a tight liquid seal between the vertical outer wall 30 of the interior skirt 28 and the vertical seal surface 68, which has been stated to be extremely smooth. Horizontal surface 66 seats against the underside of angled wall 24 and neck bead 80 and vertical top wall 38 accurately seat together. Hence, an extremely tight seal is made possible.

To separate the container of FIG. 1, said consumer should first grip the frangible tear band 60 and pull upwardly and to the left, causing the outer skirt 36 to tear along the horizontal tear line 54. Said consumer then pulls the frangible tear band 60 outwardly away from the said neck 74 causing the outer skirt 36 to tear along the horizontal tear line 54 so that the entire tear strip below the said tear line 54 is removed. To remove the upper section, said consumer then applies an upward prying force against said upper section 10 thus breaking the seal at first bead 40 and horizontal shoulder 82.

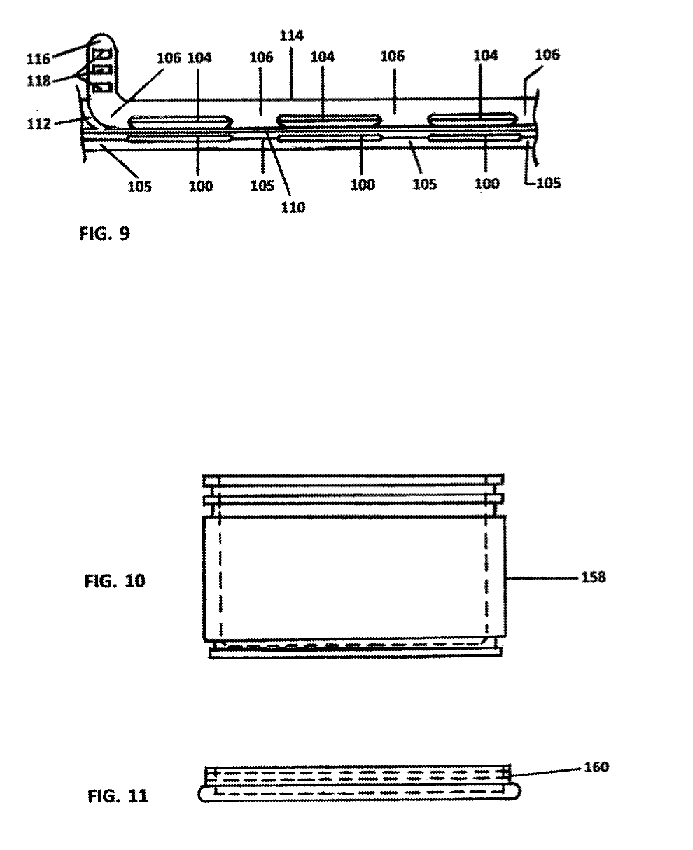

FIG. 4, FIG. 6 and FIG. 9: Show another alternate embodiment of the container; directing attention to the lid as illustrated in FIG. 4 and shown best in detailed in FIG. 6, the lower portion of the sectional view of FIG. 6. The lid comprises a bottom disc 94 having a planer under surface similar in design of said upper container section 10 tamper evident outer skirt 36 assembly. It is noted that said lid cover 20 does not include within its design the internal sealing skirt 28 as detailed in the upper section 10. Extending from the top of said disc 94 is a substantially vertical outer skirt 96. Considering the inner surface of vertical outer skirt 96, extending up from said disc 94 is a short vertical wall 98 that terminates in an internal lower bead 100. Above internal lower bead 100 is an outwardly slanted surface 102 which terminates at the lower horizontal tear line 110. Above said tear line 110, is an internal upper bead 104 which merges with a substantially upwardly-outwardly inclined upper surface 108.

Directing attention to the angled external surface 120 of said base 18, said angled external surface 120 slants inwardly and down to terminate at intersecting vertical wall 134. Horizontal shoulder 132 intersects with said wall 134 which extends to form a second external upper bead 130. Below said upper bead 130; extending down and inwardly, an outwardly slanted surface 128 intersects with a lower periphery vertical wall 126. Said lower wall 126 ends at the outwardly horizontal shoulder 124 which connects with the first vertical surface 122; creating lower first external bead 123. Vertical surface 122 extends to bottom disk 94. Said bottom disk 94 has a relative flat interior surface with no interior sealing walls.

As is best shown in FIG. 6 and FIG. 9, beads 100 and upper bead 104 are not continuous (not circumferential) but are interrupted with short gaps 105 and upper short gaps 106, respectively. Hence, the wall thickness of the vertical outer skirt 96 at the said gaps 105 and said gaps 106 is considerably thinner than at the lower bead 100 and upper bead 104. This permits stretching of the vertical outer skirt 96 during assembly. The upper bead sections 104 between said gaps 106 are considerably longer than gaps 106 and allow for stretching during assembly. The lower beads 100 are considerably longer than gaps 105 which allow for stretching during assembly. Said long beads 100 prevent lid cover 20 from being removed when the vertical outer skirt 96 is intact. Spaced immediately above the top surface of bead 100 is a horizontal tear line 110 formed on the interior of vertical outer skirt 96 to permit tearing. Extending upwardly in a slightly spiral configuration is spiral tear groove 112 which extends from the top skirt edge 114 of vertical outer skirt 96 to merge with the horizontal tear line 110. A frangible tear band 116 which may be easily gripped with a finger; depends from the lower edge of top skirt 114 immediately to one side of spiral tear groove 112. To facilitate gripping frangible tear band 116, raised traverse ridges 118 may be formed thereon. It will be noted that the upper short gap 106 of upper bead 104 are spaced downwardly from the horizontal tear line 110.

FIG. 4 and FIG. 9 show that when the consumer wishes to separate the lid cover from the container's bottom, he should first grip the frangible tear band 116 and pull upwardly and to the left, causing the vertical outer skirt 96 to tear along the spiral tear groove 112. The consumer then pulls the said tear band 116 outwardly, along horizontal tear line 110 so that entire tear strip is removed. To remove the lid cover 20, the consumer then applies a downward prying force against the top disk 94 thus breaking the seal at the internal lower bead 100.

### DETAILED DESCRIPTION OF ANOTHER PREFERRED EMBODIMENT

FIG. 10, FIG. 11 As shown in FIG. 10, the alternate lower base 158 has molded at its bottom edge and detailed in FIG. 6 an external bead 123 along the periphery of said base 158. Said external bead 123 connects with horizontal shoulder 124 which connects with vertical surface wall 126. Said wall 126 extends upwards to intersect with angled external surface 120. It should be noted that only one external bead is mold incorporated in this embodiment.

As shown in FIG. 11, and detailed in FIG. 6, an alternate lid cover which comprises a bottom disc 94 and having a planar under surface similar in design to said lid cover 20 without the frangible tear band 116 attached. Considering the inner surface of vertical outer skirt 96 extending up from said disc 94 is the short vertical wall 98 that terminates at the internal lower bead 100. Above internal lower bead 100 is an external vertical wall 126 that ends to the top edge of said lid cover 160.

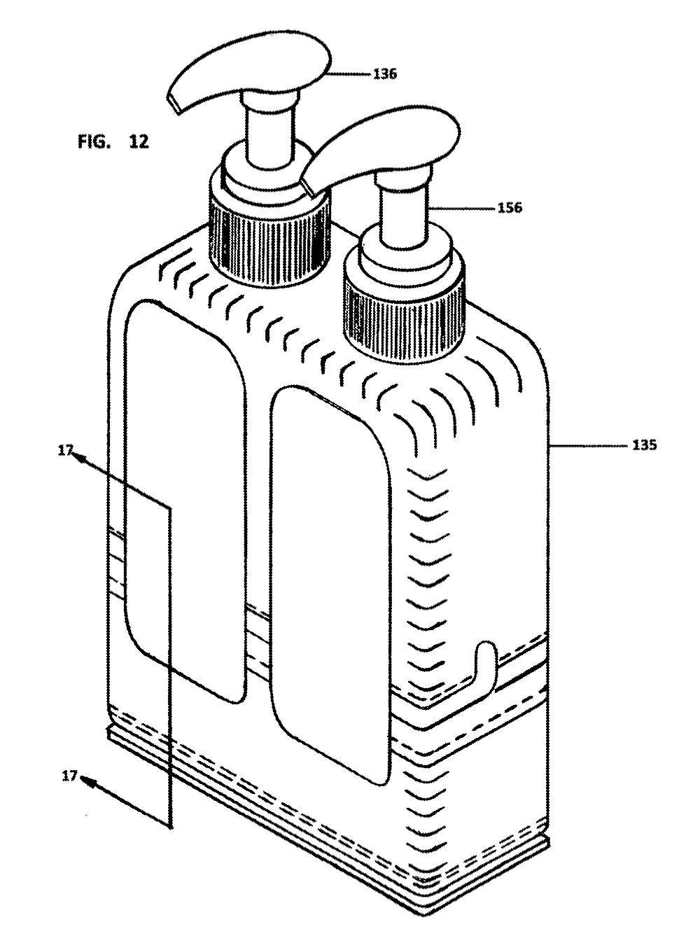

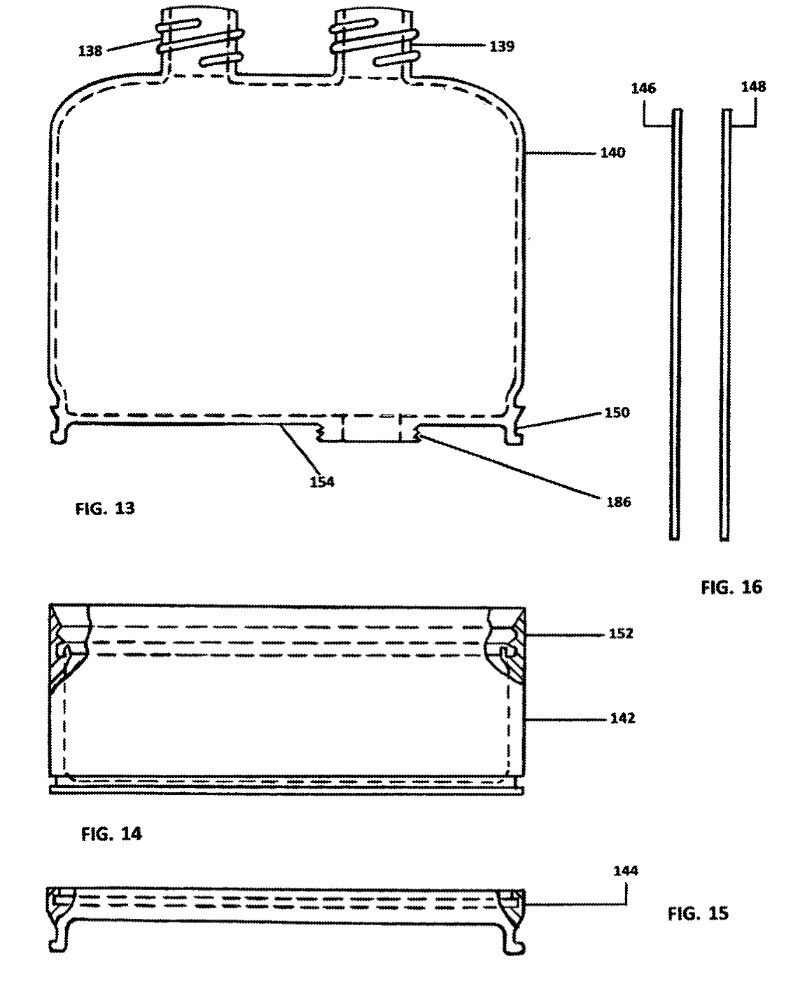

### FIG. 12, FIG. 13, FIG. 14 Another Preferred Embodiment

Referring to FIG. 12, two disclosed finger operated pump dispensers PD 136 and PD 156 are attached to the top of the sectional dual dispensing container 135 by attaching to the upwardly extending necks 138 and 139 of the dual dispensing container 135. The said pump dispensers PD 136 and PD 156 may be of any commercially available type such as finger-operated pumps used for dispensing healthcare lotions, creams, and soaps. The lower portion container (base) 142, in its assembled position is locked into the bottom edge of dual dispensing upper container 140 by means of the upper tamper evident closure 150. Attached underneath the said base 142 and locked into its assembled position by means of a tamper evident closure 152, is the lid cover 144 for said base 142. Considering the said container 135 in its assembled position; located and adhered to the front and rear surface of container 135 are two adhesive product information labels 146 and 148.

The present invention; used in this alternate embodiment makes possible dual dispensing of two different liquids used in combination by consumers (hair conditioners & shampoo, facial scrubs & cream, or foaming cleansers & lotions, etc.). The said upper section 140 of present container design is molded to an increased width to accommodate an additional finger actuated pump assembly; there is a widening of the lower section (base) 142 which provides for additional liquid storage. A preferred placement of containers liquids would have the lower section (base) 142 contain the heavier bodied lotions while the upper section 140 would have the more fluid liquids (facial cleansers, sanitizing soaps, etc.).

Referring to FIG. 12, FIG. 13, FIG. 14, FIG. 15, FIG. 16 the assembly of the upper section 140 and lower section (base) 142 is performed by means of a downward movement of upper section 140 to the seated position of FIG. 12. The lower skirt of the tamper evident closure 150 stretches to permit the slanted neck surfaces of the said base 142 to slide over the beaded surfaces of said closure 150. Simple downward compression of said upper portion 140 into the closure 152 of said base 142 snaps into its position against the bottom surface of upper section 140. In this position, which locks the two sections together, provides for a tightly sealed container 135. As shown FIG. 16, front label 146 and rear label 148 are installed after assembly of said container.

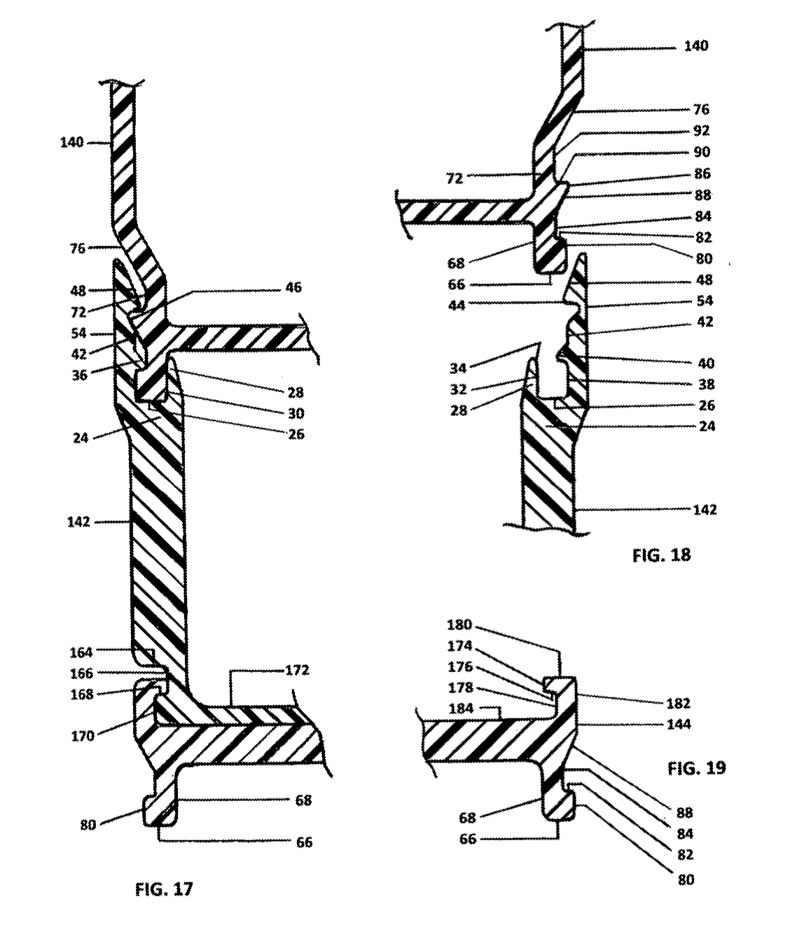

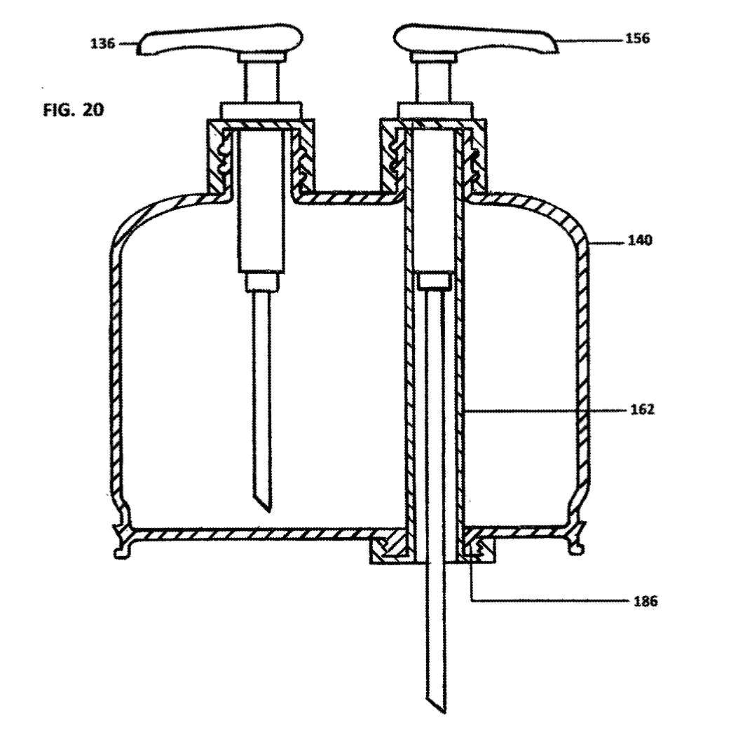

Referring to FIG. 17, FIG. 18, and FIG. 19 The upper section 140 comprises along the bottom edge an external neck 72. Directing attention to FIG. 17 and FIG. 18; an angled exterior surface 76 of said upper section 140 slants inwardly to terminate at vertical surface 92. Horizontal shoulder 90 intersects with slanted surface 88 to form the upper exterior bead 86. Below said upper bead 86 and extending vertically is surface 84 which intersects with the horizontal shoulder 82. Said shoulder 82 extends to form the second external neck bead 08. Directly beneath the said bead 80 is the horizontal sealing surface 66 which rests on the smooth planar surface 26 when assembled. As shown in FIG. 17, the tamper evident outer skirt 36 has been mold incorporated into the top edge of lower section (base) 142 having identical internal and external bead designs.

Directing attention to FIG. 17 and FIG. 19; the bottom edge of said base 142 shows the horizontal surface 164 which intersects with the circumferential vertical bottom wall 166. Said bottom wall 166 intersects with the horizontal bottom lip 168 which extends downwardly to form the vertical external bead 170, which is mold to create the base bottom surface 172. As shown in FIG. 19, lid cover 144 comprises a horizontal top surface 180 that intersects with the vertical short wall 174 an extends down to connect with the horizontal short lip 176. A vertical catch wall 178 is formed with the intersecting of top surface 184.

The exterior surface of the said lid cover 144 contains a vertical outside wall 182 that extends and intersects with slant surface 88, and intersects with vertical exterior surface 84. The said vertical surface 84 intersects with horizontal shoulder 82. The external neck bead 80 is formed just below horizontal shoulder 82 and above the horizontal sealing surface 66. The sealing surface 66 intersects with the vertical sealing surface 68 then intersects to form the bottom of lid cover 144.

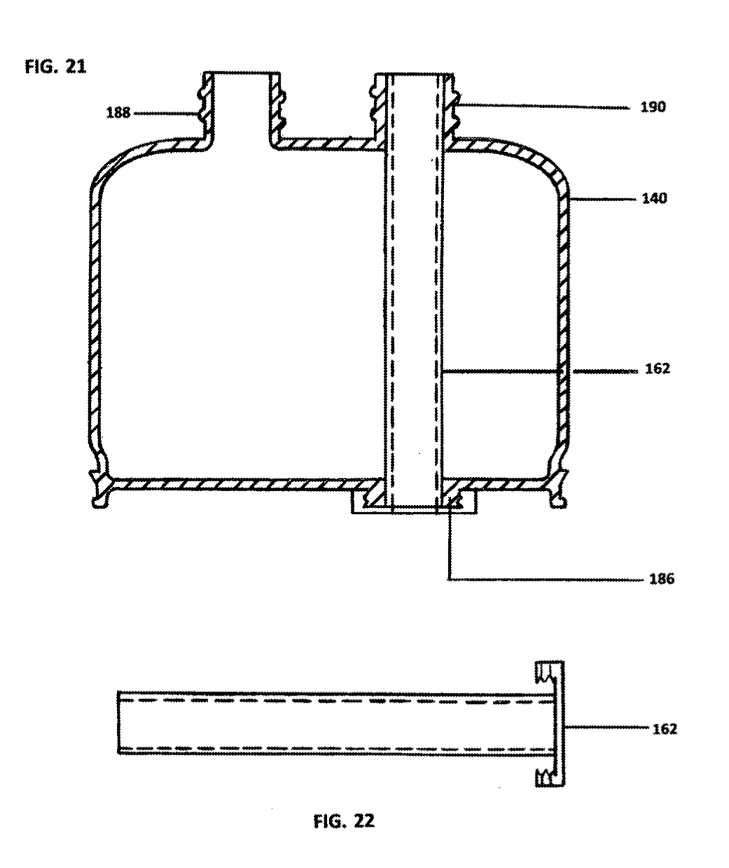

Referring to FIG. 20, FIG. 21, FIG. 22 As shown in a sectional view in FIG. 20, the assembled components of the dual dispensing upper section 140 contains two finger actuated pump assemblies 136 and 156. Also shown in assembly is the screw-in channel tube 162 that attaches to the downward extending neck 186. In FIG. 21 and FIG. 22, said screw-in channel tube 162 extends up and through the interior of upward extending neck 190. In FIG. 22, the screw-in channel tube 162 is detailed to show the mold incorporated screw threads at is edge. The said channel tube 162 is injection molded to various lengths to accommodate various container sizes.

What is claimed is:

1. A sectional bottle container, comprising:
a hollow body container having an upper section and a lower section that are detachable from one another, the upper section including an upwardly-extending neck;
a finger actuated pump assembly coupled to the upwardly-extending neck such that liquid product contained in the hollow body container may be selectively dispensed by manipulation of the finger actuated pump assembly; and
a tear-off closure band arranged around a bottom of the upper section and a top of the lower section;
wherein removal of the tear-off closure band allows the upper section of the hollow body container to be separated from the lower section, thereby providing access to contents remaining in the lower section after the finger actuated pump assembly fails to dispense all of the liquid product contained in the hollow body.

2. The sectional bottle container of claim 1, wherein the tear-off closure band is molded as an integral portion of the hollow body container.

3. The sectional bottle container of claim 1, wherein the upper and lower sections of the hollow body container are individually molded and are subsequently assembled together.

4. The sectional bottle container of claim 3, wherein the individually molded upper and lower sections of the hollow body container are subsequently assembled together by compression fitting the upper section to the lower section to provide a liquid tight seal.

5. The sectional bottle container of claim 1, wherein the upper section of the hollow body container includes a downwardly-extending wall removably coupled to an upwardly-extending neck of the lower section of the hollow body container.

6. The sectional bottle container of claim 5, wherein the tear-off closure band forms a portion of the downwardly-extending wall.

7. The sectional bottle container of claim 6, wherein a tear line is defined between the tear-off closure band and the rest of the downwardly-extending wall.

8. The sectional bottle container of claim 7, wherein the tear line is defined by scoring and/or weakening along a lower portion of the downwardly-extending wall.

9. The sectional bottle container of claim 5, wherein the downwardly-extending wall forms an outer skirt, and wherein the upper section of the hollow body container further includes a downwardly-extending inner skirt.

10. The sectional bottle container of claim 9, wherein the upwardly-extending neck of the lower section of the hollow body container is disposed, prior to separation of the lower section from the upper section, between the outer skirt and the inner skirt.

11. The sectional bottle container of claim 5, wherein the downwardly-extending wall of the upper section includes a first bead, wherein the upwardly-extending neck of the lower section includes a second bead, and wherein the upper section and lower section are coupled together, prior to separation of the lower section from the upper section, via the interaction of the first bead with the second bead.

12. The sectional bottle container of claim 1, wherein the tear-off closure band includes a tab at an end thereof.

13. The sectional bottle container of claim 12, wherein the tab may be gripped by fingers and pulled outwardly away from the hollow body container to facilitate separation of the upper section of the hollow body container from the lower section.

14. The sectional bottle container of claim 1, further comprising a repositionable lid cover that is detachable from a bottom of the lower section of the hollow body container, the repositionable lid cover including a peripheral wall that is sized and shaped to be coupled to the upwardly-extending neck of the lower section of the hollow body container such that the lid cover covers a top of the lower section.

15. The sectional bottle container of claim 14, wherein the tear-off closure band is a first tear-off closure band, wherein the sectional bottle container further comprises a second tear-off closure band arranged around the repositionable lid cover and a bottom of the lower section, and wherein removal of the second tear-off closure band allows the repositionable lid cover of the hollow body container to be separated from the bottom of the lower section and coupled to the top of the lower section.

16. A sectional bottle container, comprising:
a hollow body container having an upper section and a lower section that are detachable from one another, the upper section including an upwardly-extending neck;
a finger actuated pump assembly coupled to the upwardly-extending neck such that liquid product contained in the hollow body container may be selectively dispensed by manipulation of the finger actuated pump assembly;
a repositionable lid cover that is detachable from a bottom of the lower section of the hollow body container, the repositionable lid cover including a peripheral wall whose size and shape corresponds to a size and shape of the upwardly-extending neck of the lower section of the hollow body container; and
a tear-off closure band arranged around the repositionable lid cover and a bottom of the lower section of the hollow body container;
wherein the upper section of the hollow body container may be separated from the lower section, thereby providing access to contents remaining in the lower section after the finger actuated pump assembly fails to dispense all of the liquid product contained in the hollow body; and
wherein removal of the tear-off closure band allows the repositionable lid cover of the hollow body container to be separated from the bottom of the lower section and coupled to a top of the lower section, thereby enclosing the remaining contents within the lower section.

17. The sectional bottle container of claim 16, wherein the tear-off closure band is a first tear-off closure band, wherein the sectional bottle container further comprises a second tear-off closure band arranged around a bottom of the upper section and the top of the lower section, and wherein removal of the second tear-off closure band facilitates the separation of the upper section of the hollow body container from the lower section.

18. The sectional bottle container of claim 16, wherein the repositionable lid cover includes a horizontal bottom disc having a vertical wall extending therefrom.

19. The sectional bottle container of claim 18, wherein the vertical wall extends upwardly from the horizontal bottom disc when the repositionable lid cover is disposed on the bottom of the lower section of the hollow body container, and wherein the vertical wall extends downwardly from the horizontal bottom disc when the repositionable lid cover is detached from the bottom of the lower section, inverted, and coupled to the top of the lower section.

20. The sectional bottle container of claim 18, wherein the upwardly-extending neck of the lower section includes a first bead, wherein the vertically-extending wall of the repositionable lid cover includes a second bead, and wherein the lower section and the repositionable lid cover are coupled together, after the separation of the lower section from the upper section and detachment of the lid cover from the bottom of the lower section, via the interaction of the first bead with the second bead.
